(19) United States
(12) Patent Application Publication
(10) Pub. No.: US 2002/0099560 A1
(43) Pub. Date: Jul. 25, 2002

(54) Information, directory, location and orientation system for retail stores and the like

(76) Inventor: Paul S. Enfield, Bellingham, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/902,923

(22) Filed: Jul. 10, 2001

Related U.S. Application Data
(60) Provisional application No. 60/217,206, filed on Jul. 10, 2000.

(51) Int. Cl. G06F 17/60

(52) U.S. Cl. 705/1

(57) ABSTRACT

A system for a retail store, such as a grocery store, for guiding and orienting shoppers with regard to product location. At various aisle locations and other locations in the store area there are provided signs with graphic representations of products which are typical of products that are located in the area of that sign. Many of these signs would be brand name graphical representations of the actual products as packaged. Also, there are directory signs, directions signs, store layout sheets or handouts and more specific product signs to also assist in orienting the customers and providing location information.

### BACKGROUND OF THE INVENTION

A. Field of the Invention

The present invention is adapted for use in a store facility which sells products, and more particularly for enabling shoppers to become better acquainted with the overall system of the store relating to location of its products, and also better enabling the shopper to find desired products more easily. Further, the system the present invention is particularly designed to take advantage of the consumer's existing awareness of various identifying features of products to facilitate this overall process of more efficient and effective shopping in the store. While the present invention is particularly adapted for use in stores which are generally referred to as “super markets”, the system of the present invention could also be utilized in other types sales facilities.

B. Background Art

In the first half of the twentieth century, the metropolitan areas generally developed where there was a core area (commonly called “downtown”) where much of the business community was located, and also where the community would do its “more serious shopping”. There were few families with two automobiles (and many with no automobile at all), and most of the people would travel to the downtown area by public transportation (electrically powered street cars and horse drawn street cars in the early part of the century, or buses). The neighboring communities that were served by the core business area (i.e. downtown) would each have local shopping centers for their more immediate needs. Thus, in most neighborhoods there would be within a half-mile of the homes a shopping center that would have as a core a grocery store, a drug store, several service shops such as barber shop, shoe repair shop, an automobile service station, an automobile repair shop, sometimes a hardware store, a book store, a variety store (cards and gifts), a delicatessen, an ice cream parlor (for on-site consumption and also carry-out orders), etc.

Then in the downtown areas there again many specialized stores. There were stores, and even these with specialties such as a ladies' clothing store, men's suits, and a soft goods store (selling the less expensive fabric items such as shirts, undergarments, etc.). There were jewelry stores, shoe stores, furniture stores, hat stores, book stores, luggage stores, opticians, etc. Some of these stores expanded partially from specific product lines, these were usually called “department stores”. The core product of the department stores was clothing, and most all types of clothing could be found (hat, shoes, undergarments, bathing suits, etc.) Also there were house wares and home furnishing.

The shops and stores in the first half of the twentieth century (both downtown stores and neighborhood stores) were well characterized in that they carried specific product lines, with very little overlap between the stores. Thus, a person would find very few products that were sold in a drugstore and also in a grocery store. The items sold in a hardware store would not be found in either a drug store or a grocery store. Automotive related items would possibly appear in a service station or repair shop but never in a grocery store, drug store, etc. The floor space of such stores was relatively small (by today's standards). For example, the grocery stores were generally neighborhood stores serving a relatively small area (e.g. a radius of possibly no more than a half mile, or even less), the floor area of the store was only a small fraction of that of even an average sized super market that we now have in the latter part of the twentieth century.

Another characteristic of a retail stores and service stores prior to World War II was that the service was highly personalized. A fair number of products were not open for public display and public handling, and in most instances these were always in display windows or on shelves and bought over-the-counter. The customer would generally ask a sales clerk where certain items were located. Also, a large number of grocery stores would give the shopper personal service and walk the customer through the store, picking out the more desirable head of lettuce, and advising the customer of products on sale. etc. Further, some of these stores would even take your orders over the phone for particular items and already have the products in cardboard containers when the shopper came to the store.

The concept of self-service stores developed in the first part of the century, and in 1917, the original patent on a self-service store was issued, U.S. Pat. No. 1,249,879 with the inventor being Clarence Sanders. A copy of FIG. 2 of the patent is shown in the drawings as FIG. 16 and designated as “prior art”. The customers would enter through a front door, go by a service counter and then make an entrance through the doorways on the left side of the drawing. Then the customers would travel through four aisle ways, and then would come to checkout counter. After passing by the checkout counter, the person would leave by the main entrance. Some inroads were made in introducing this type of store, but in general the consuming public was slow to adapt the “do-it-yourself” mentality. It was only many years later when there were self-service gas stations where you could fill your own gas tank, and wash your own windshield.

Shortly after World War II, there began some trends that caused basic changes in the distribution and sale of substantially all consumer products. There was the proliferation of the automobile, the “flight to the suburbs” and building of freeways. (With the cold war well underway in the 1950's there was a strong push by President Eisenhower for a network of freeways throughout the nation so that our transportation would not be paralyzed in the event of a war, and this reached through the metropolitan areas. Also, with the metropolitan areas expanding geographically with great rapidity, the need for more roads and more freeways grew rapidly.

This led shortly to the very large suburban shopping centers, and most all of these had expansive parking lots. Prior to World War II when a person was taking, for example, an electrically powered streetcar to the downtown shopping center, the streetcar would be obliged to stop at every block where there was a person who wanted to get on or get off a streetcar, and a three mile trip could take from twenty to thirty minutes. But a four to seven mile drive to the shopping center (at least in the 1950's when the traffic jams were less severe in most metropolitan areas) it could be a five to ten minute drive to a shopping center. Thus, a centralized shopping center that would develop in the 1950's or 1960's would be serving a customers within a radius of possibly two to five miles, instead of a half mile in the pre-World War II times. Thus, the “grocery store” now became a “super market” many times larger than the neighborhood grocery stores.

Then there was another trend which increased the shopping area of these super markets, and this was that the product lines themselves were expanding. There were no longer the well defined lines of grocery stores, drug stores, hardware stores, book stores, clothing stores, etc. Also, there is proliferation in the types of food products being offered. Food technology made rapid advances, and the variety of various food products increased dramatically. For example, in the 1930's, the dominant dried breakfast cereals were Kellogg's Corn Flakes and Wheaties from General Mills. The dominate hot cereals were Quaker Oats, Cream of Wheat, Wheatena and the Ralston breakfast cereal. Twenty years later this had multiplied many times over. Also, the trend toward consumer convenience resulted in many new bakery products and “ready mix” products. Early on there was the one step biscuit mix (Bisquick by General Mills), and then came the various cake pre-mixes and pre-mixes for other bakery products.

Another example is that no longer would someone buy potatoes only in the natural state in a bag, to then prepare them at home in different ways, such as mashed potatoes, scalloped potatoes, baked potatoes, etc. And now potato-products are also pre-made, such as frozen shoe string potatoes, pre-mixed packaged of scalloped potatoes, etc.

Possibly the greatest proliferation of variety of food products is the in the area of frozen food products. In the first part of the twentieth century frozen food products were rare even though some technical advances were made. For example, in the 1930's a patent issued to Clarence Birdseye on a method for preparing frozen food. The inventive feature was that the food product was compressed at the time it was being frozen to eliminate as much of the ambient air as possible within the package to minimize oxidation. Now most every type of food product can be bought in the frozen form, such as vegetables, fruits, pies, pizzas, fully prepared meals (made up of meat, potatoes, and vegetables), desserts, yogurt, chicken, meat packs, etc.)

In a medium sized super market, where there are, for example, eleven aisles of food products, with each aisle being 120 feet long, the person would be traveling approximately 1320 feet (one quarter of a mile) to take the tour down all twelve aisles in making his or her food selections. The greatly increased floor area of the super market makes shopping difficult.

The people designing the layout of super markets have attempted to cope with this in various ways. First, historically like food products have been generally located in the same parts of the store so that, for example, most canned goods would be found in the same area. Thus, if a person is looking for canned salmon, the person would probably find the canned vegetables and canned fruits and fruit juices in one area and then migrate over to the canned soup, and then find canned meat and seafood. As a further customer convenience, the super markets will now commonly have text information signs either at the end of an aisle or a middle location in the aisle, where general categories or representative of where food products are displayed. For example, the general category of “snacks”, pet food, coffee, salad dressing could be listed. However, even with that being done, a person coming into a super market for the first time, trying to shop for possibly fifteen different items, would possibly spend a larger proportion of time in the super market simply finding the general location where the food would exist than in making the actual selection. Even then, it would take many trips to that particular super market to become familiar with the distribution pattern. For example, if there ten aisles in the store and there are signs at opposite ends of that aisle indicating the types of foods in each half of the aisle, and if there are, for example, between four to six items specified in each aisle, this would be a listing of about 100 different food items. It would take a fair number of trips to the store for the person to commit all these locations to memory.

Now, as part of the background information relating to present invention, let us turn our attention to a rather different aspect of merchandising of products, such as products in a super market, and this is the broad category of product identification. This leads us into the broad areas of trademarks, advertising and merchandising. The term “trademark” as its origin many centuries ago where an artisan, such as a silversmith, would stamp his “mark” on his product, much in the manner of a cowboy would put the brand of cattle owner on the cattle. The trademark of artisan would identify the source of the goods as that particular artisan, and also serve as a mark of quality commensurate with the skill of that artisan.

As time went on, the term “trademark” became to be interpreted much more broadly. The most familiar trademarks are word marks, and these include such terms as “Wheaties”, “Chevrolet”, “Starbucks”, “Boeing”, “Kodak”, “Apple”, “Xerox”, etc. Also, a trademark can be made of numbers and/or letters. For example, there is “V-8” for a food product, “M & M” for candies, “IBM” for computer related products, etc.

To give other examples, there are character marks (either real or imaginary), such as the “Jolly Green Giant”, “Aunt Jemima” for pancakes, the image of a Quaker on the Quaker Oats package, the picture of the young girl with an umbrella for Morton Salt, etc. Some of these images probably contribute more toward product identification than does the actual word mark. For example, the young lady in the bonnet on the Sunkist raisins could be an example.

Further, the graphics on the container can sometimes function as very strong trademarks. One example of this is the red and white checkerboard pattern of Ralston products such as Ralston Purina. The origin of this mark is told to be along the following lines. When the founder of this company was a young boy, he worked in a dry goods store in a small town. It was the custom for people to buy a large bolt of cloth and then to sew their own clothes. This one particular family that had numerous children had purchased a large bolt of cloth with the red and white checkerboard pattern, and much of the clothing of their children was made with this particular cloth. Whenever this family came to town, it was quite easy to identify who the children of this family were and where they were, simply by their red and white checkerboard clothing. This made such an impression on this young man that he later adopted this for the trademark to be applied to the various Ralston products.

Also, the container configuration can function as a trademark, and an example of this is the distinctive shape of the Coke bottle. Another is the distinctive configuration of the “pinch bottle” of Haig & Haig scotch whiskey.

Combinations of colors (an even in some instances a single color, such as the color pink for Corning Fiberglass), can also function as trademarks. The color pattern on Hawaiian Punch is another example.

Producers of food products take great care and will often do considerable research in the selection of the brand name of a product, and also the overall presentation of the artwork and format of the packaging. The goal of the overall presentation of the product in both the name and the packaging is to make it attractive, distinctive, and help sell the product.

Over the last century various fads have developed in the promotion of the marks, some of which were short lived. For example, at least more than a half century ago when a soft drink such as a Coca Cola or a “Dr. Pepper” was still a nickel, there was a singing commercial as follows:

“Pepsi Cola hits the spot;

Twelve full ounces, that's a lot;

Twice as much for a nickel too;

Pepsi Cola is just the drink for you”.

The radio listeners of that era were fortunate in that this particular fad had a relatively short life.

With the several paragraphs above giving attention to the trademarks and the advertising efforts of promoting the same, let us now turn our attention to how these products are actually merchandised in today's supermarkets. In large part, the proper promotion of the product in any particular store would be the location of the product and the amount of shelf space. If the product is located closer to eye level where it can be more easily observed, this is more desirable.

Another avenue is to offer specials from time to time. Sometimes the grocery store itself will use this as lead items, and a product such as coffee would be advertised as a special to bring the customers into the store and thus increase the sale of other items as well. In some instances, the food product would be given a choice advertising location in the store.

However, in large part, the creative efforts given in the selection of the mark and the presentation of the packaging in the environment of the super market only has its effect when the customer sees the product itself on the store shelf. It is only in that brief moment that it has its effect. In other respects, the producer of that product must rely upon other kinds of advertising exterior of the super market.

It is with the foregoing in mind that the system of the present invention was developed. In general, the system of the present invention is designed so that the overall make-up of the store is more “user friendly” in that the customer is able to become more familiar with the arrangement and location of the various store products more quickly, and especially for the first time shopper to be able to accomplish his/her shopping more quickly and with less effort. In another sense, the system of the present invention is designed to provide a much more effective communication link with the overall layout of the store. One important aspect of the system of present invention is to take advantage of the fact that producers of food products and other products that are sold in super markets have made substantial expenditures in several ways of obtaining strong consumer recognition of their products, in efforts all the way from the initial selection of the trademark, formatting of the packaging, and formatting of the graphics on the packaging to the advertising of the products through the media. The present system uses this to enhance the convenience of the shopper in the shopping chores in the super market or other facility.

### SUMMARY OF THE INVENTION

The system of the present invention is designed to facilitate customer shopping in a store facility, such as a supermarket. The store facility has store products in a shopping area where the products are categorized as follows:

a. a plurality of display signs, each of which is located at a related access region for viewing by customers at or proximate to that related access region, each of said display signs having at least one graphic product representation of a product which is one of said adjacent products and is representative of products in its related secondary location related product category or subcategory at said related access region;

b. said display signs being positioned in a substantial shopping area portion of the shopping area and located at a substantial number of access regions in said substantial area portion, such that a customer passing through the access regions in said store shopping area portion is able to associate said graphic product representations as representative of products in a subcategory and/or a secondary location related product category of the product or products of the graphic product representations, and thus identify primary, secondary and/or subcategory location in the shopping area portions as a guide to seeking products in the substantial shopping area portion where the graphic product representations are present.

The shopping area has a plurality of consumer access regions which are proximate to the products in the shopping area and through which customers are able to pass in making product selections from products that are adjacent to that access region. Each of the access regions is characterized in that the adjacent products are classified in one or more of the secondary categories and/or subcategories.

The system of the present invention comprises a plurality of display signs, each of which is located at a related access region for viewing by customers at or approximate to that related access region. Each of the display signs has at least one graphic product representation of a product which is one of the adjacent products and is representative of products in its related secondary location related product category at related access region.

This system is characterized in that the display signs are positioned in a substantial shopping area portion of the shopping area and located at a substantial number of access regions in the substantial area portion. This is done in a manner that a customer passing through the access regions in the store shopping area is able to associate the graphic product representations as representative of products in a subcategory and/or a secondary location related product category of the product or products of the graphic product representations. This enables the customer passing through the access regions to identify primary, secondary and/or subcategory locations in the shopping area portions where the representations are present as a guide to seeking products in the shopping area portions where the graphic product representations are present. In a preferred embodiment, at least some of the products of the graphic product representations display a brand name and the brand name is visible in the graphic product representations. Also, in the preferred form, at least some of the products of the graphic product representations have a brand name and the brand name is visible in the graphic product representations. Also, in the preferred embodiment, at least some of the graphic product representations have a package design which is visible in the graphic product representations in a further preferred embodiment, at least some of the products have both the brand name and the package design, and both the brand name and the package design are part of the graphic product representations which are substantially accurate representations of the brand name and associated package design.

In another embodiment of the present invention, there is a store directory which is visible to customer in the shopping area and the store directory lists identifying names of the products, with at least some of the names of the identifying products having a graphic product representation substantially displaying the brand name product which is within the scope of the product listed in the category.

In a further embodiment, there is also at least one display direction sign indicating direction to a store location or locations and providing identification of the store location or locations by means of a graphic product representation of the brand name product or products that is representative of the products in that location or locations. In another embodiment of the present invention, there is a store directory which is representative of the shopping area showing various product locations in the store area. Further, these store locations are identified by graphic product representations of specific products representative of products to be found at that location.

In another alternative form of the present invention, there is a plurality of these store directories with the representations of the shopping are showing various product locations and identifying these by graphic product representations of specific products. Each of these is placed on a substraight that is portable manually so as to be able to be given as a hand out for store information and/or for advertising and/or other purposes in conveying information on the store facility. In a preferred embodiment, a substantial percentage of the products in the shopping area are food products and food related products. The primary location related product categories include at least frozen food products, refrigerated food products, fresh (perishable) food products, and canned/bottled/packaged food products. The access regions of the store facility comprise at least elongated aisles with product shelves along the aisles, and each aisle is provided with at least one display sign which has displayed thereon one or a plurality of graphic product representations of products representative of a secondary location related categories and/or subcategories of food products on shelves along that aisle.

In a preferred form, in addition to the aisle display signs, there are category directory signs with graphic product representations at spaced locations along at least some of said aisles. These category directory signs at the spaced locations are more specific to product categories at the spaced locations along the aisle. In the system of the present invention, there is present at least one aisle located in freezer cabinets, and the category directory signs are at spaced locations along said aisle at which the frozen products are present. Also, in the preferred form, the category directory signs are located along an aisle or aisles of the store facility that present “drugstore” products, and other products as wine, specialty products, etc.

In a further embodiment, at least some of the display signs have in addition to the graphic products representation or representations text identifying products and/or categories of product at the related access region. In one preferred form, the store facility has existing display at the access regions which display text identifying products and/or categories of products at the access region, and graphic product representations are displayed in addition to the text. In one form, the portion of the sign displaying the text is an existing sign, and the display sign portion showing the graphic product representations are mounted to the existing text display signs.

Other features of the present invention will become apparent from the following detailed description.

### BRIEF DESCRIPTION OF DRAWINGS

FIG. 1 is a plan view showing the layout of a typical present day prior art supermarket;

FIG. 2 is a view similar to FIG. 1, but showing somewhat symbolically the location of signs of the present invention of the store facility of FIG. 1;

FIG. 3 is a perspective view of a display sign of a first embodiment of the present invention;

FIG. 4 is a view similar to FIG. 3, but showing the first embodiment from a further distant location, with additional signs of the first embodiment;

FIG. 5 is a view showing a front view of the display sign of the first embodiment;

FIG. 5A is a front view of a modified form of the first embodiment;

FIGS. 6 and 7 are front view signs of two category display signs of the present invention;

FIG. 8 is a perspective view showing category signs, such as shown in FIGS. 6 and 7 positioned along a frozen food aisle.

FIG. 9 is a front view of a display sign of the present invention functioning as a direction giving sign.

FIG. 10 is a front view of an upper left corner of a store directory of the present invention;

FIGS. 11A-11F are figures where pairs of display signs are shown (two for each figure) which were used in a case study in a supermarket to demonstrate benefits of the present invention;

FIG. 12 is a plan view of the store facility, similar to that shown in FIGS. 1 and 2, but showing graphic representations of products at various locations throughout the store;

FIG. 13 is a front view of an existing text sign to be used in a sixth embodiment;

FIG. 14 is a frontal view of the sixth embodiment of the present invention where the word section of the sign has a mounting frame mounted thereto, with the pictorial graphic representation portion of the sign being mounted to the mounting member;

FIG. 15 is a sectional view at a typical location of the mounting member;

FIGS. 16 and 17 are representations giving the data obtained by a case study done in connection with the present invention;

FIG. 18 is a copy of a figure from an earlier patent illustrating an early version of a self-service store.

### DESCRIPTION OF THE PREFERRED EMBODIMENTS

A preferred implementation of the system of the present invention is to incorporate this in a present day super market, and the preferred embodiments will be described in this environment. However, it is to be understood that within the broader scope of the present invention, the system of the present invention could be used as advantageously possibly in other shopping environments where similar problems and opportunities would exist.

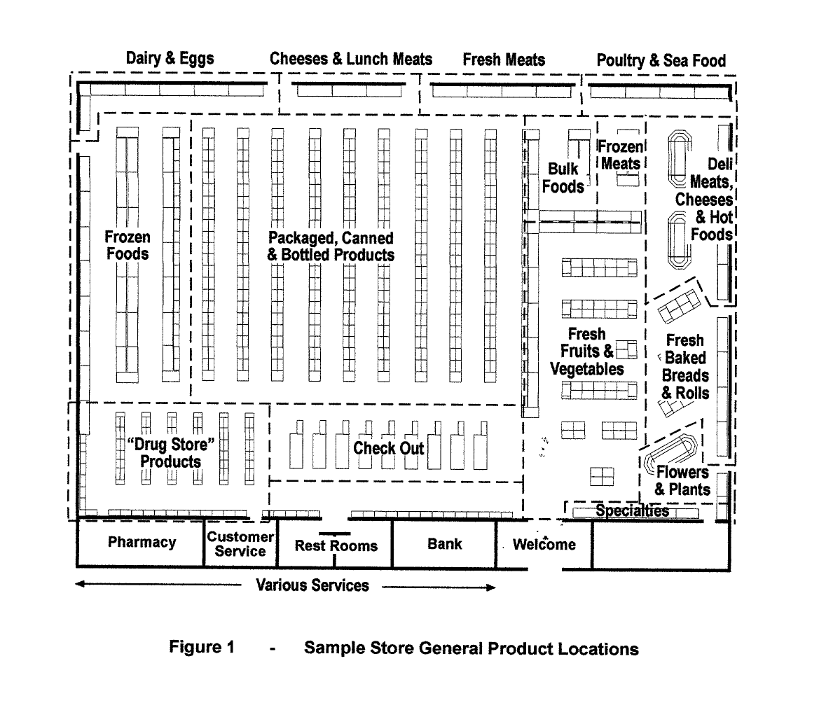

It is believed that a clearer understanding of the present invention will be obtained by first discussing the overall classification of products that might be sold in today's super market, and then to examine these as they relate to a floor plan of a typical super market, such as shown in plan view of FIG. 1.

The products which commonly appear in a super market could be placed in eight categories, five of which are food product categories. These are as follows:

| | |
|---|---|
| a. | Fresh (perishable food products) |
| b. | Frozen Food Products |
| c. | Refrigerated Food Products |
| d. | Bulk Food Products |
| e. | Canned/Bottled/Packaged Food Products |
| f. | “Drug Store” products |
| g. | Other Products |
| h. | Various services |

These eight categories have been developed more or less in accordance with historical trends.

i. Fresh (Perishable Food Products)

These comprise mainly of fresh fruits and vegetables. These are commonly placed in table top containers for easy access, and in terms of quantity of product sold in the store have increased in recent decades, mainly due to greater access to tropical markets so that these can be supplied on more a less on a year around basis. A number of decades ago, it was common to buy this sort of produce in various “farmers markets” on a more seasonal basis. It can be seen in the floor plan of FIG. 1 that the fresh fruit and vegetables could occupy a fair amount of floor space in the store.

ii. Refrigerated Products

It can be seen in the floor plan of FIG. 1 that these are largely positioned along the perimeter walls of the super market, and this would normally would be done for practical reasons, since there must be adjacent refrigerating equipment. The percentage of floor space of refrigerated products sold in modern day super markets is a substantial increase from the grocery store of decades ago. As indicated earlier, milk products were in the first half decade of the 20^{th} Century commonly sold by door to door delivery as were other dairy products. Meat products were commonly sold in a butcher shop. Now these appear in supermarkets. There is a sufficient variety in refrigerated products that some of these could be considered as comprising primary categories in themselves.

iii. Frozen Food Products

These also are of more recent origin, and this in large part due to more recent developments in the technology of being able to freeze various products without any significant loss of the palatability or the overall quality of the food.

As indicated previously, many (if not most) products which appear in other parts of the store would also appear in the frozen food section. These frozen food products are commonly kept in cabinets with a below freezing temperature. Alternatively, some of these products, such as these frozen vegetable packages, fruit juice, etc. are kept in three to four feet high refrigerated open topped chest style containers. In the plan view of FIG. 1, there is a section indicated as frozen foods and the open topped containing areas are shown as extending down the middle of the area, thus forming two aisles. As illustrated, these open top chests are flanked on each side by upright displays. These can be either open fronts or in most cases today, glass doors. It is sometimes time consuming to find the product the person wants, since it is necessary to peer into each of the transparent doors of the cabinets.

iv. Bulk Food Products

These are of more recent origin. The common denominator for these products is that they are made up of discreet particles which are not overly fragile, and also have a relatively long shelf life. These can be things such as peanuts, cereals (e.g. oatbran), candy, beans, trail mix, etc.

v. Canned/Bottled/Packaged Food Products

In the Floor Plan of FIG. 1, it can be seen that in terms of floor space taken up in the super market, this is the largest category. Also historically, its roots go back furthest, and mainly to the grocery store as it existed in the first half of the twentieth century and earlier. However, the product lines have become more numerous and not just simply different brands in the same type of products, but newly created products such as the convenience packaged foods (which can be reconstituted by being mixed with water to make casseroles, pasta dishes, etc.). Also certain basic commodities, such as rice are packaged along with a seasoning packet to make a basic part of a meal very conveniently. It is of interest to note that certain basic food products such as vegetables, can fall into a number of these broad categories. For example, the vegetable product can be a fresh vegetable, a canned vegetable, a frozen vegetable or a dehydrated vegetable that is packaged as a convenience food product. As a further option, some vegetables and fruits can be dehydrated and consumed in that form (e.g. dehydrated peaches, prunes, etc.) that campers commonly use.

vii. Drugstore Products

In a typical supermarket, this section in terms of floor space may be substantially less than other product lines, but in terms of the number and variety of products, it ranks high numerically. This would include many of the over-the counter remedies for pains, colds, athletes' foot, hemorrhoids, allergies, etc. There are the various personal care products such as deodorants, shampoo, shaving products, toothpaste, etc.

viii. Other Products

This category, like the “Drugstore Products”, although in a relatively small floor space ranks high numerically in terms of the number of different products that appear here. This could be any of a wide variety of items for which people shop for frequently, such as batteries, towels, wash cloths, cookware, some simple automotive products, etc. This could also include such things as magazines, video rentals, greeting cards, gift wrapping, etc.

ix. Other Items of Interest

Some products that appear in super markets don't fall easily into any one of the categories mentioned above. One of these “in between” product lines is bread and rolls. It is a processed product in that it is prepared and cooked and it is also a perishable product in that it will soon go stale. It seems that it doesn't logically totally belong in any one of the categories recited above, and the bread and roll section often ends up as being located in what is left over after the other locations are taken.

Also, in Floor Plan, FIG. 1, the category of flowers and plants. A good location for this is where is has immediate consumer attention, since it often subject to impulse buying, such as a person buying some flowers for a spouse or for someone who may be ill, possibly buying a plant as a gift, etc. Also a deli could be included.

Prior Art Product Locating Signs

As indicated earlier, in some instances there will be a product directory in one part of the store indicating various food items on which these might appear. In addition (as also indicated previously), there are commonly signs which will be placed at an aisle location at an elevation such as eight or more feet above the floor level either at the end of the aisle or at an intermediate location listing several food products. In some instances, the quantity of a type of products may take a sufficiently large amount of shelf space so that it would be adequate to give a generic name on the sign. This would be, for example, a term such as “snacks” or “snacks, cookies and crackers”. In other instances, the products are of sufficient variety such that only a sampling of certain products can be listed. From this listing of several products, the person could infer that other related products could be in that same aisle area.

While this obviously does not give an accurate listing, it does have some merit. In general, supermarkets will tend to group certain products together. For example, if there is a bulk food item such as flour one might expect to find other food items that would relate to baking, such as sugar, salt, spices, leavening, etc. Also if one would see an item such as a canned or bottled fruit juice, one might expect that canned fruit might not be too far away. However, to illustrate the substantial variations that can occur, below there are listed the items that appear in fifteen different aisles in one supermarket of medium to large size. There are twenty-two aisles in all. These are as follows:

| | |
|---|---|
| 1. | Paper Plates, Cups, Charcoal, Aluminum Foil, Facial |
| | Tissue, Toilet Tissue, and Paper Towels. |
| 2. | Mixers, Nuts, Popcorn, Soda Pop. |
| 3. | Juice, Kool-Aid, Jams and Jellies. |
| 4. | Canned Beans, Dried Beans, Canned Vegetables, |
| | Sauces, Potato Chips, Snacks. |
| 5. | Cat Food, Dog Food, Pet Supplies. |
| 6. | Canned Sauces, Hot Cereal, Pasta, Pancake Mix, |
| | Syrup. |
| 7. | Sugar, Flour, Gelatin Milk, Cake Mixes, Flour, Spices. |
| 8. | Soup, Oatmeal, Prepared Foods, Canned Fish, |
| | Mexican Food, Shortening. |
| 9. | Coffee, Coffee Filters, Instant Coffee, Cocoa, Pickles, |
| | BBQ Sauce, Salad Dressing. |
| 10. | Crackers, Cookies, Tea, Ice Cream Topping. |
| 11. | Brooms, Mops, Automotive, Batteries, Light Bulbs. |
| 12. | Bleach, Wax, Dish Soap, Cleansers. |
| 13. | Soft Goods, Laundry Supplies, Diet Aids. |
| 14. | Bread, Rolls, Books, Magazines. |
| 15. | Promotional/Seasonal. |
| 16. | Hand Lotion, Eye Care, Soap Bar, Cover Girl |
| | Cosmetics. |
| 17. | Vitamins, Antacid, Headache Remedies, Cough and |
| | Cold Remedies. |
| 18. | Shaving Razor Blades, Toothpaste, Deodorant, Dental |
| | Needs. |
| 19. | Shampoo, Hair Care, Candles. |
| 20. | Baby Food, Toys, Baby Wipes, Feminine Hygiene. |
| 21. | School Supplies, Stationary, Shoe Care, Hosiery. |
| 22. | Bakeware, Glassware, Pyrex/Corning, Housewares, |
| | Party Supplies. |

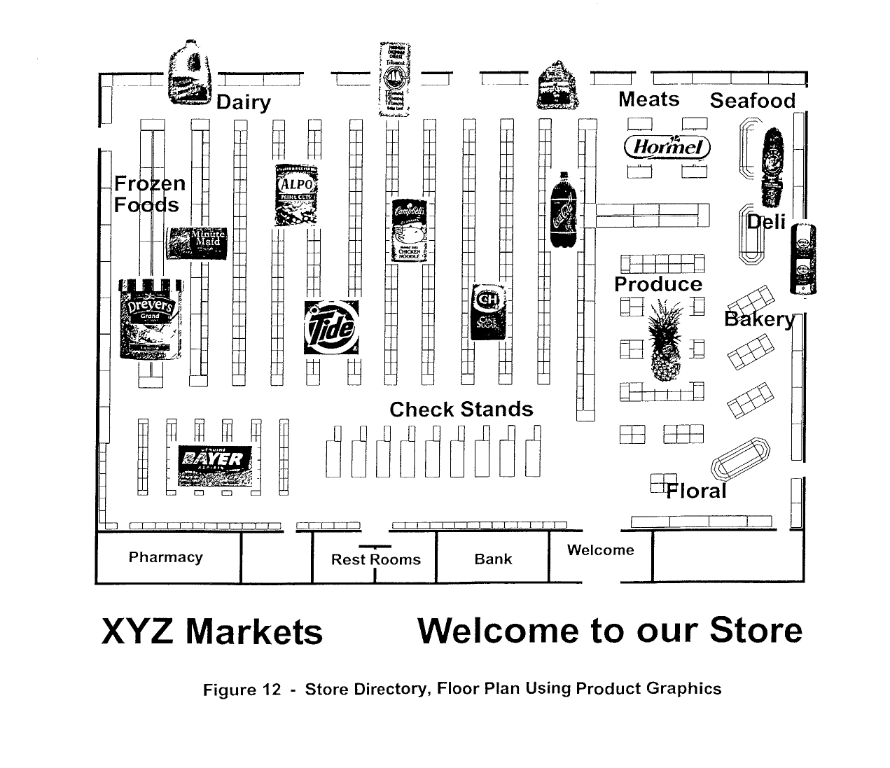

Then for a comparison, the reader should view FIGS. 12A through 12L which show twelve signs which the existing word signs that appear in a super market, with the displays of the present invention being position above the signs. These are the signs used in a case study in single supermarkets. These will be discussed later in this text but, for the moment, reference is made to these FIGS. 12A though 12L so that the reader can obtain a comparison between the variety of items which might appear on the word signs in the aisle of a supermarket.

With the foregoing being given as background information there will now be a description of the various embodiments of present invention.

### DESCRIPTION OF THE PRESENT INVENTION

Overall System.

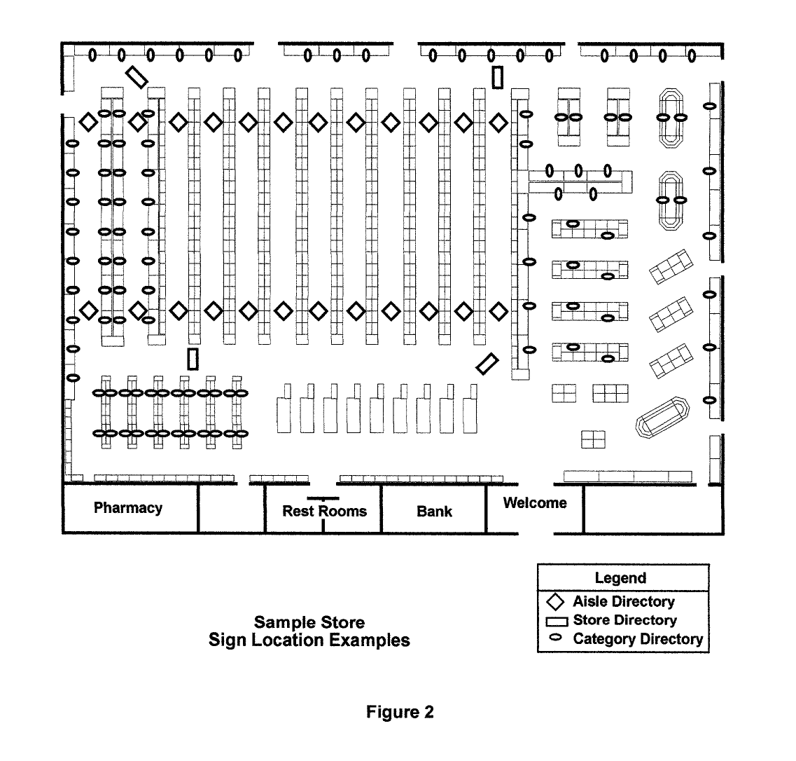

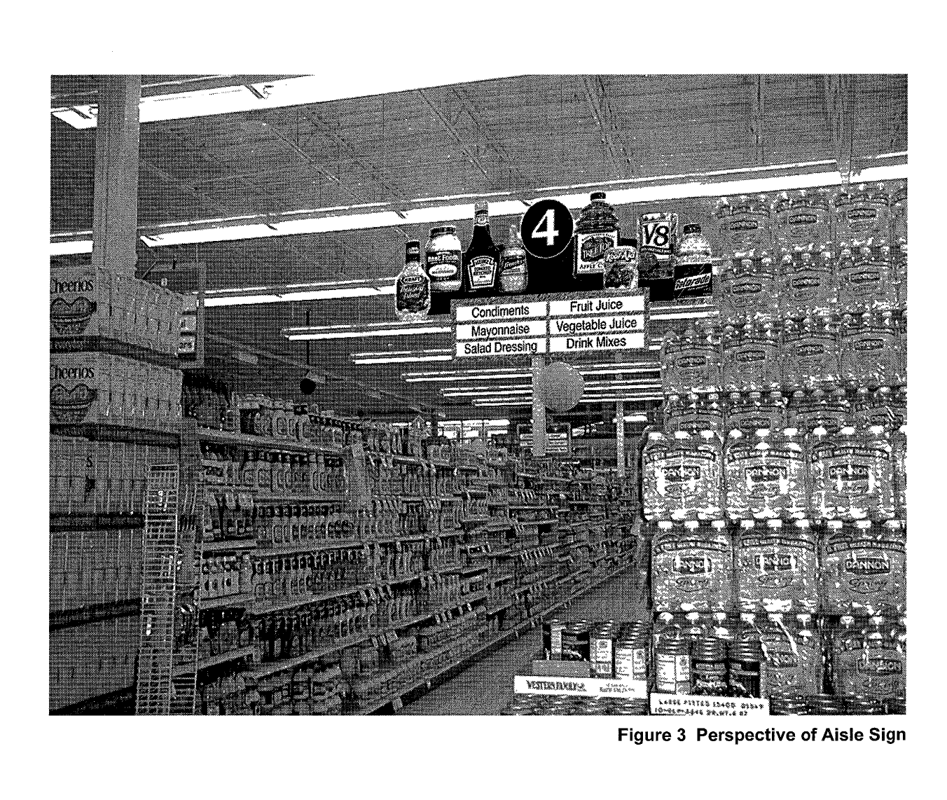

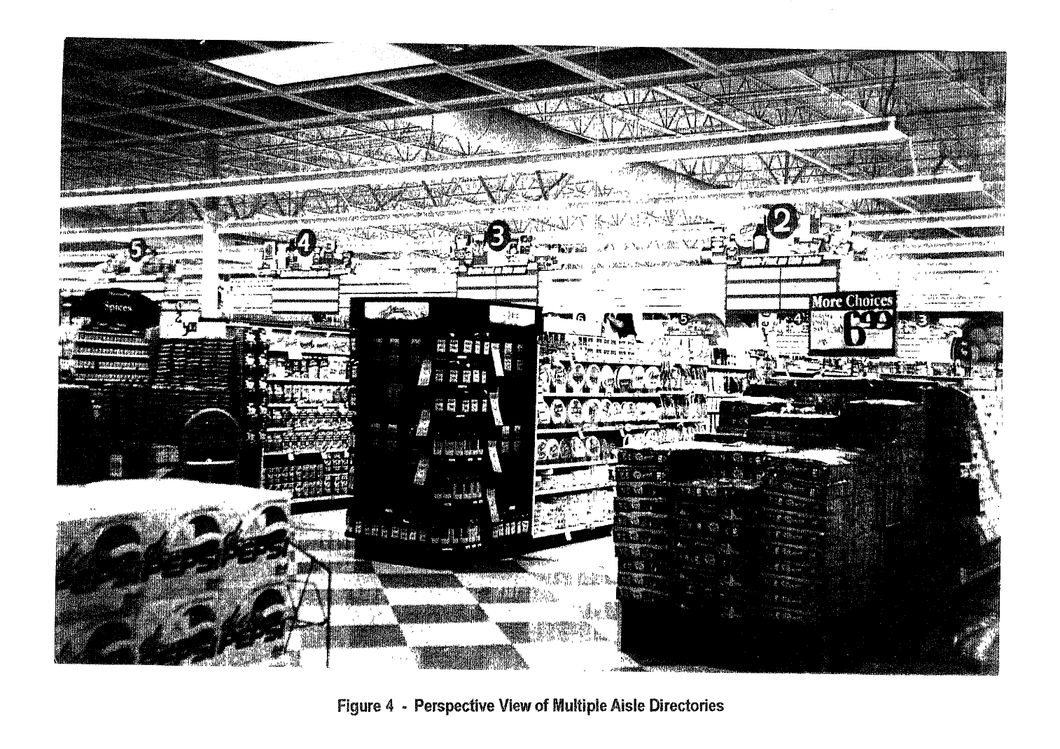

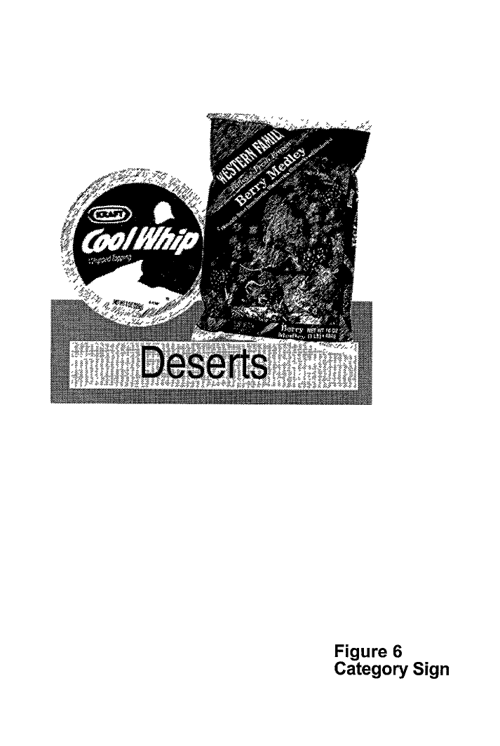

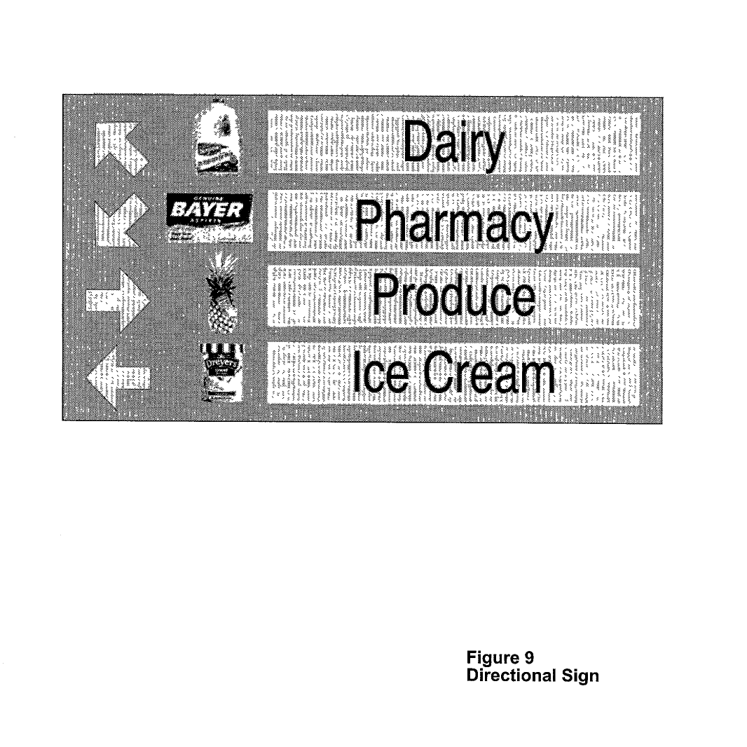

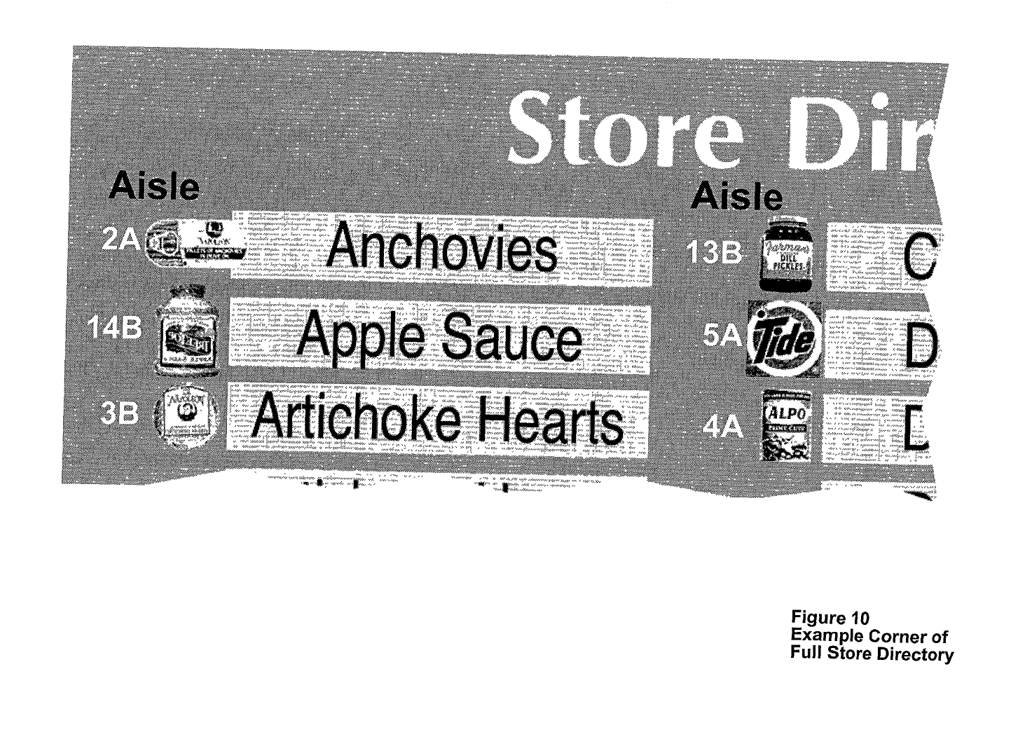

To describe the overall system of the present invention, reference will be made first to FIG. 2. It can readily be seen that FIG. 2 shows the same floor plan of a supermarket as shown in FIG. 1, but there are various symbols superimposed thereon. It can be seen that a diamond shaped symbols represent an aisle directory sign such as shown in FIGS. 3, 4 and 5. The rectangular symbols represent an overall store directory where the various the products are listed alphabetically, and just a small portion of this sign is shown in FIG. 10. Then the horizontally aligned oval symbol represents a more specific category directory, a sign such as indicated at FIGS. 6, 7 and 8. There is a sixth type of sign shown in FIG. 9 and this is a direction sign indicating a direction in which certain classes of products could be found.

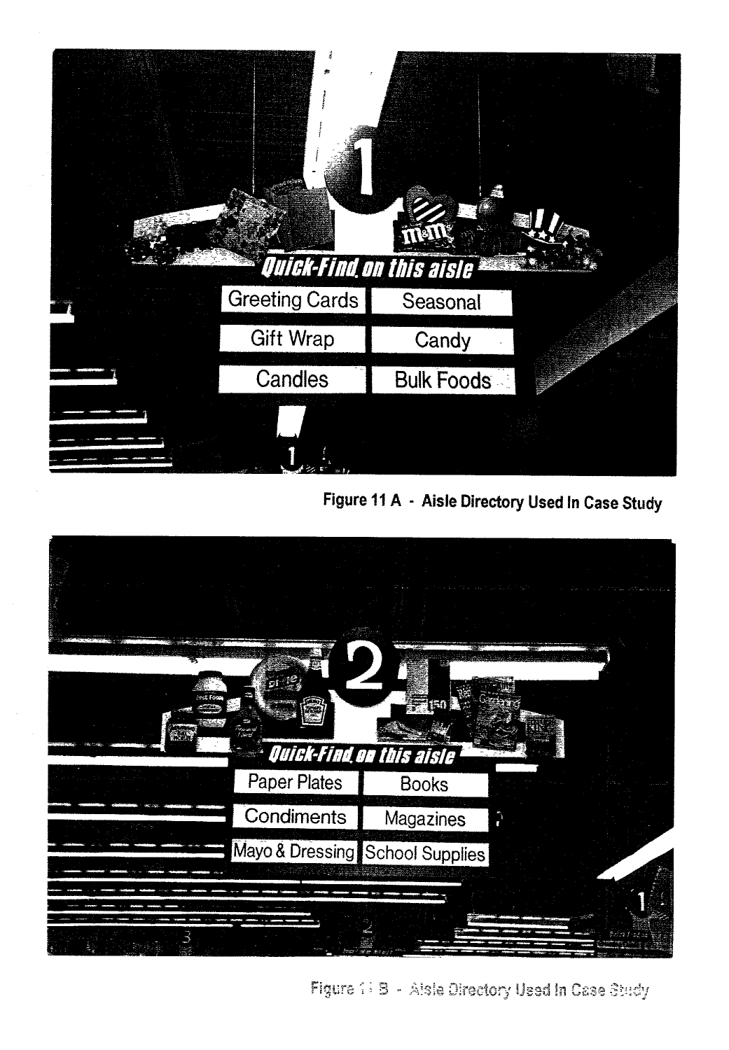

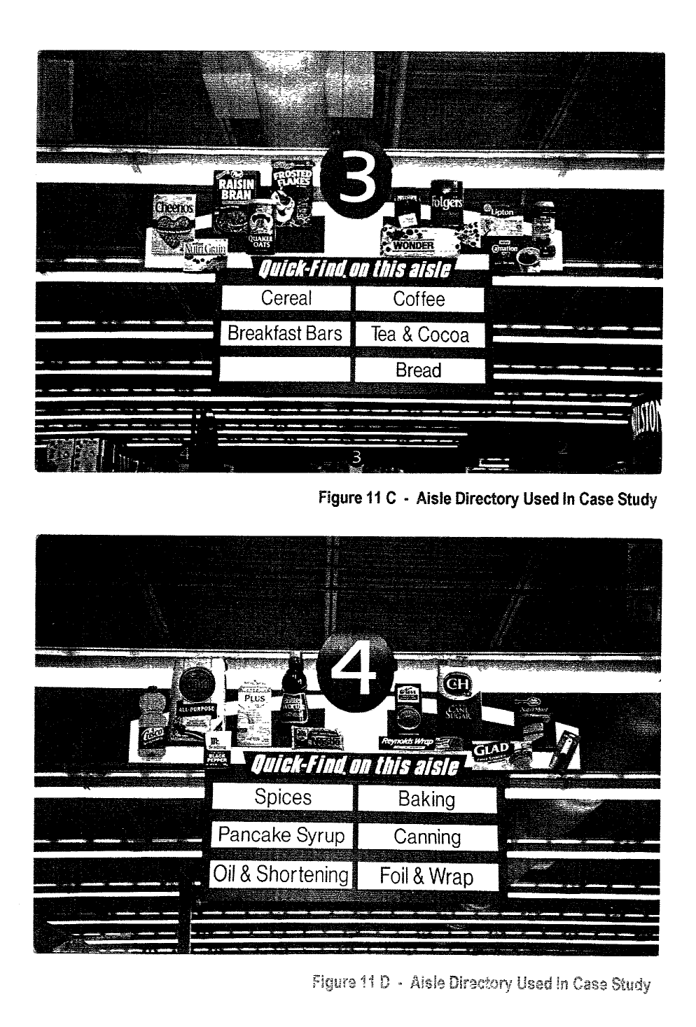

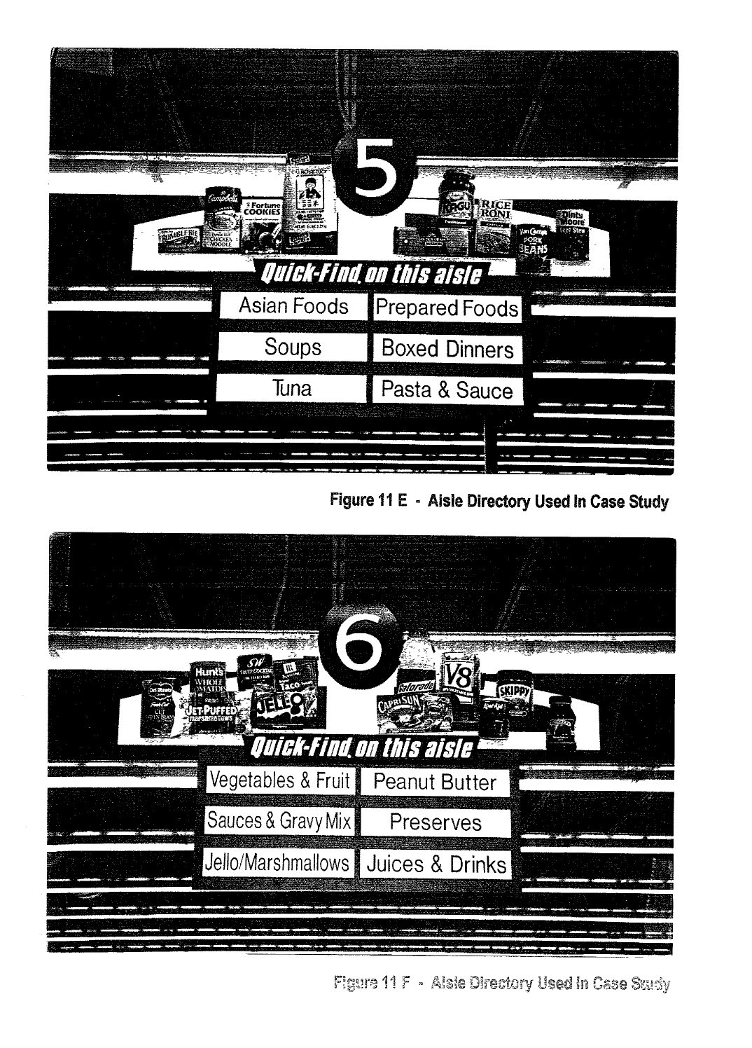

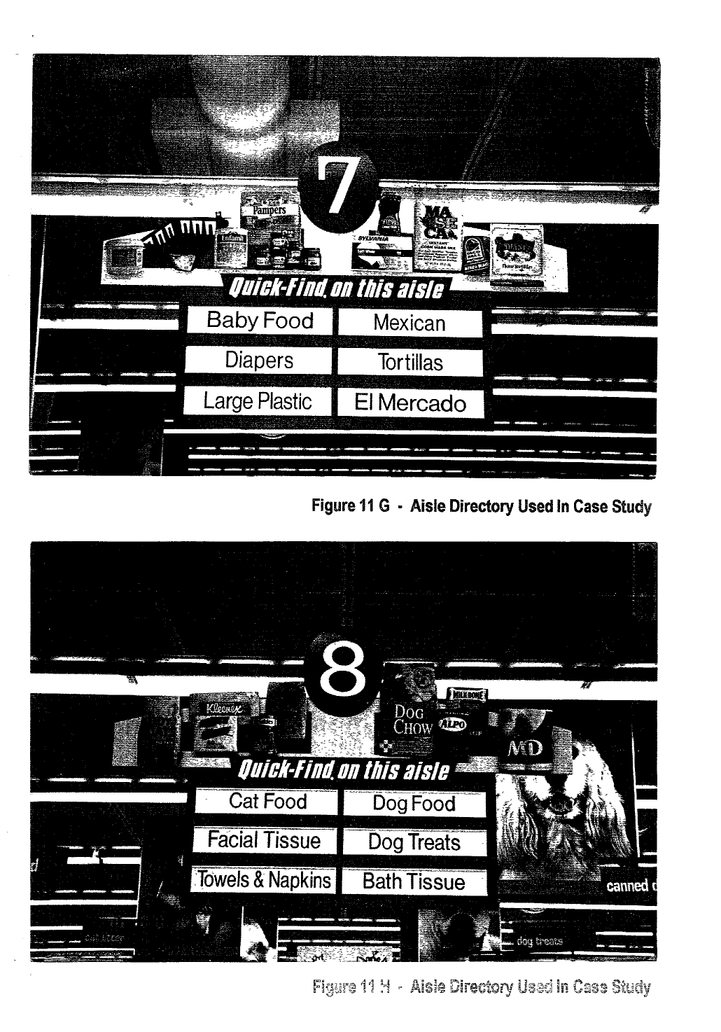

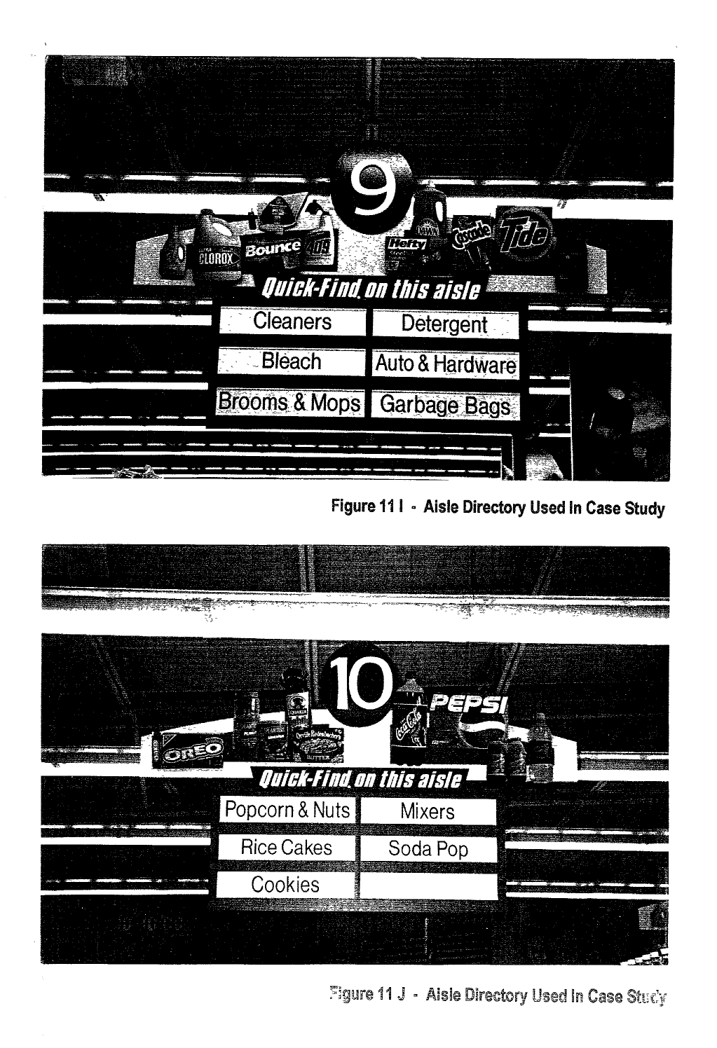

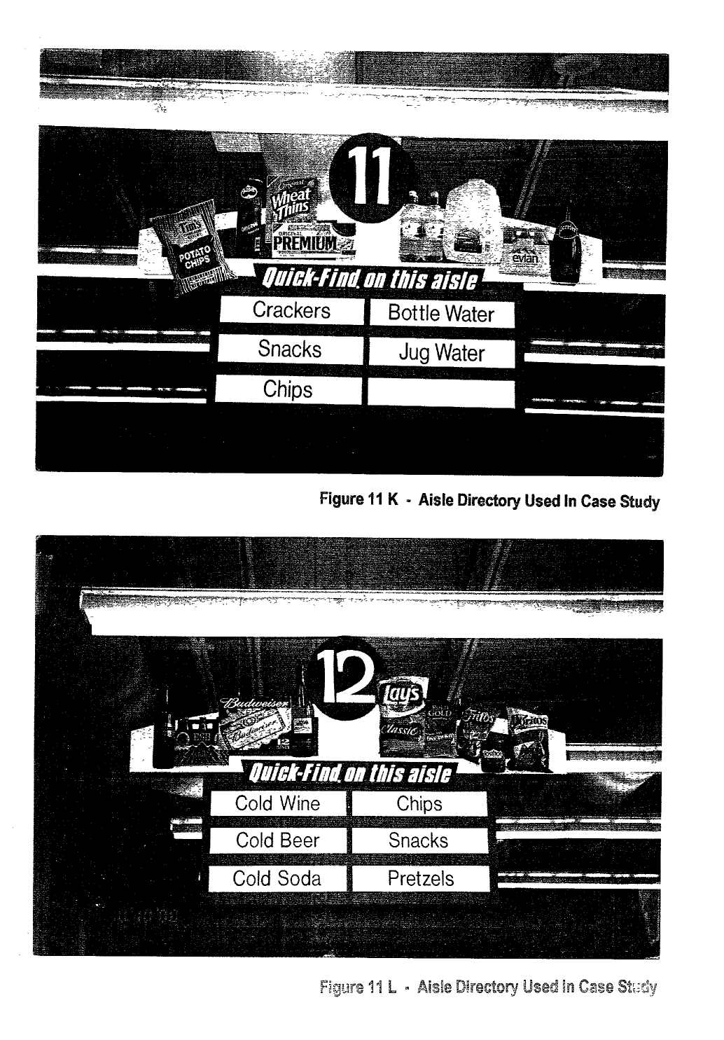

Finally, there is shown in FIG. 11, a floor plan of the store, substantially the same as shown in FIGS. 1 and 2. In addition there is displayed on this Plan View of the supermarket, symbols showing the locations of various products. This can be used as a consumer hand-out on a sheet of paper, or a more detailed larger presentation (ea. two foot by three foot sign) of this same format.

By way of further introduction, it is believed it would be helpful in discussing the underlying principles of the present invention to arrive at terminology which will be used.

Definition of Terms.

a. The term “primary location related product categories” shall in this text refer to the rather broad categories of products which would be sold in generally the same sub-area of a supermarket in a supermarket. In this text, we shall consider the eight major categories that were presented earlier in this text as being these primary location related product categories. As indicated above, these eight are the following:

Fresh (perishable food products)

Frozen Food Products

Refrigerated Food Products

Bulk Food Products

Canned/Bottled/Packaged Food Products

“Drug Store” products

Other Products

Various services

b. The term “primary location area” shall mean that area of the supermarket where the related primary location related products are located in the store. For example, the term “frozen foods area” is a primary location related to that product category, and the area of the supermarket where these frozen foods are located will be the “primary location area” for frozen foods. It should be noted, however, that depending upon the make up of the store, the related primary location area may not be one contiguous area, but might actually be separated into two or more locations of the store. For example, the “refrigerated food area” could well be spread over different areas of the store, such as refrigerated beverages being in one location of the store, refrigerated unprocessed seafoods as being in a second location, etc.

c. The term “secondary location related product categories” shall mean the secondary categories which are within the scope of a single primary location related product category. For example, frozen vegetables would be a secondary location related product category within the broader scope of refrigerated food products.

d. The term “secondary location area” shall mean that location or locations where the related secondary location area products are located.

e. The term “sub-categories' shall be used somewhat generally to designate more specific categories within a related secondary location related product category. Thus, refrigerated beverages would be a secondary location related product category, and refrigerated soft drinks or refrigerated fruit juices could be a sub-category.

f. The term “sub-category or sub-category location area” would mean a location or locations where the sub-category products are located.

g. The term “specific food product” shall mean a product such as “canned tuna” or “fresh oranges”.

h. The term “specific brand name product” shall mean a specific food product identified by a particular brand name. For example, “Chicken Of The Sea” tuna is a specific brand name product for canned tuna. The term “Aunt Jemima pancakes” is a specific brand name product referring to particular pancake mix. Also, the term “Wheaties” is a specific brand name product for a specific dry breakfast cereal, while the term “dry breakfast cereal” would likely be considered a sub-category.

i. The term “brand name” shall mean the actual name of the product, and this brand name of the product would in most all instances function as a trademark. Thus, “Chicken of the Sea Tuna” is a brand name. “Wheaties” is a brand name. Also, a brand name such as “Campbell's” could apply to a number of different products.

j. The term “trademark” shall mean the trademark that is used to identify that product, and it is quite often a word mark. For example, the brand name ° Chicken of the Sea Tuna” contains the trademark “Chicken of the Sea” followed by the generic name of the product, namely tuna. Likewise “Tree Top” is a trademark of the brand name which is “Tree Top Apple Juice”.

k. The term “brand name product representation” shall mean a reasonably faithful reproduction (or at least a substantial reproduction relative to overall appearances) of the actual representation of the product (usually a packaged, bottled or canned product) as it would appear on a store shelf. Thus, the “brand name product” representation for “V-8 Juice” would be a pictorial representation of the actual can containing the “V-8 Juice” product with the mark “V-8” appearing on the can and also all of the graphic representations. Also, if the container for the product has a stylized configuration, such as the somewhat distinctive bottle of “Heinz Tomato Ketchup”, the brand name product representation shall also faithfully represent that container configuration. It is to be understood that positioning and scale of these elements may be adjusted to aid in identification. Also, in some instances the logo or brand name alone (quite often in a stylized form) will suffice. Within the broader scope of the present invention, the representations could be three dimensional images, or artistically styled representations of the products.

First Embodiment of the Present Invention

References first made to FIGS. 3, 4 and 5 which shows the aisle sign directory of the present invention used in combination with the existing word sign that is already on display in the store. In this instance the brand name product representations are:

“KRAFT THOUSAND ISLAND DRESSING”

“BEST FOODS MAYONNAISE”

“HEINZ TOMATO KETCHUP”

“FRENCH'S MUSTARD”

“TREE TOP APPLE CIDER”

“KOOL AID DRINK MIX”

“V-8 100% VEGETABLE JUICE”

“GATORADE” soft drink

Also, it will be noted that the brand name product representation of each of these is a representation of each of the actual products.

Also, as an alternative, if there were not an existing word sign on the aisle, this sign showing the eight brand name representations could be used by itself as a product directory for that particular aisle. Such a sign could be located at two end locations of the aisle. There could also be a middle aisle directory sign between the two end directories. Also, if the aisle is not of great length, it may be that one aisle directory sign at a center location of the aisle would suffice.

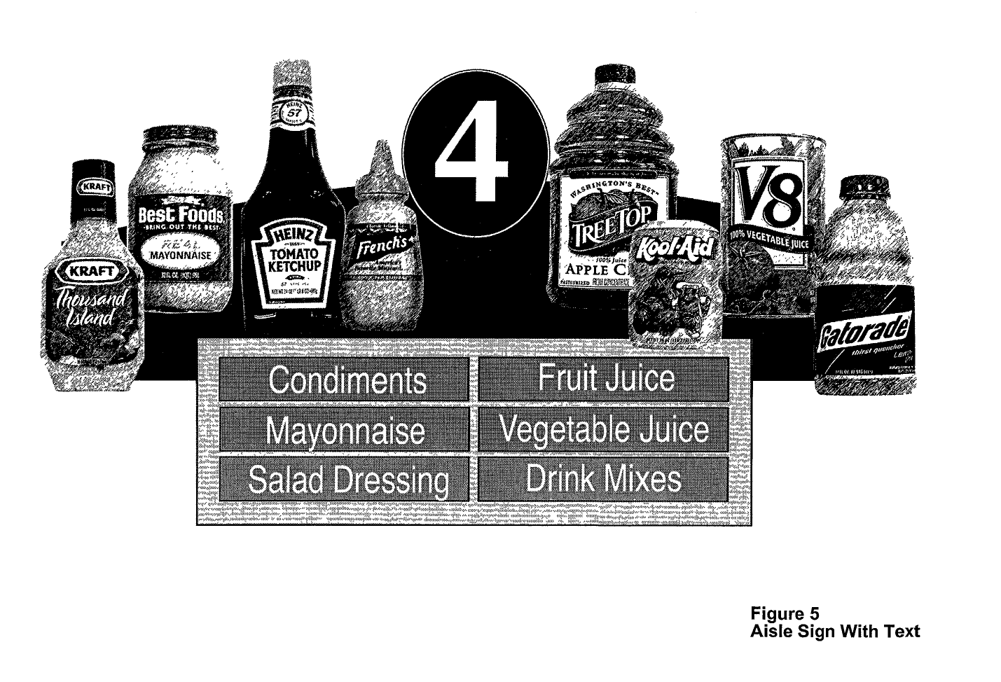

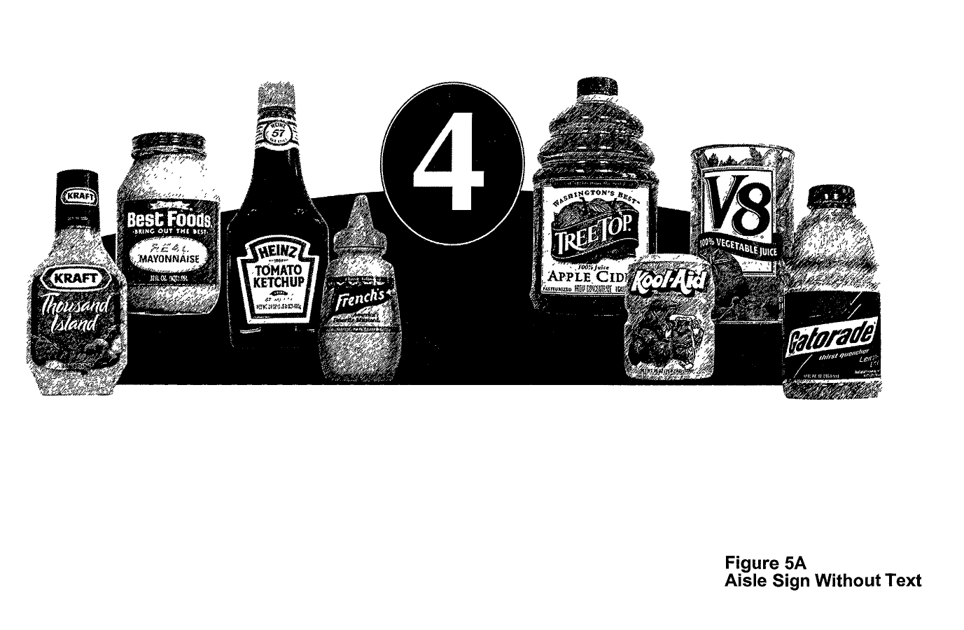

In FIG. 5A, there is shown an aisle directory sign similar to that shown in FIG. 5, except that the word sign is eliminated, and brand name product representations could be somewhat different.

Let us now pause for a short while and dwell on what is being accomplished by this representation of these brand name products. Most all of us recall the old adage, “a picture is worth a thousand words”, but let's take it a little bit deeper look than that. First, we have to recognize that the people who have designated the overall graphics of each of these products have likely put in a lot of effort to see that these have been artistically done to make the representations distinctive, and also pleasing to eye. In each of these there is a certain artistic balance. Further, when these various product representations are arranged in a collage, this itself can be done rather attractively (and is done attractively in each of these representations), so that the components of the collage itself have a certain artistic flair and balance.

What is the effect of all this? One is that it catches one's attention and gives a person a number of “memory hooks”.

So let's look at the practical benefits. First, using the signage of the present invention where the actual brand name product representations are shown, the information inherent in the sign can be comprehended more quickly by the customer. The applicant has reviewed studies that have shown that when people are given a random list of one hundred products and one hundred brand name icons, (i.e. the graphic representations of the actual product), the icons will be identified several times faster than the text description of the same items. Thus, a photograph of a bottle of “HEINZ KETCHUP” will be identified much more quickly than the wording “KETCHUP” standing alone.

Further, as indicated above, by seeing the brand name product representation, it can be remembered more easily. The location of products in the store is much easier to recall when the product representation are viewed. For example, a person with mental picture of a collage of condiments over an aisle of a supermarket will remember the location more readily than when a sign using a simple text description is used. This makes it more “user friendly”, and thus a new customer entering a store for the first time will be likely to return to that same store.

Another benefit is that people who are not all that familiar with the English language or those who are poor readers will have an easier time identifying the product by the brand name product representation.

Beyond that, this stimulates greater customer interest in that these displays are more “eye catching”. As indicated above, graphics and especially color graphics, when properly done, add to visual appeal by giving a sense of “activity”. This adds visual appeal.

Another “fringe benefit” of using these brand name product representations is that many (if not most) of these products have been advertised so that they already have some customer recognition. Thus, when a person views the graphics of that particular product, it is already familiar to him and his mind latches onto it more quickly. This makes it easier to remember. Another related “fringe benefit” is that by using these brand name product representations, it is giving exposure to the artistic and creative inputs of the people who have created the artwork for these brand name product representations. Skilled and creative artists and craftsmen have already formulated the graphics and the balance of the same, and this is a way of passing this on to the customer and yet giving the customer useful information. To state this in other terms, the customer in traveling through the store aisles is given a series of eye pleasing representations instead of a large number of word signs. Further, many (if not most of these representations would be in color to be more distinguishable and eye catching, and also more easy to remember.

In the representations of FIGS. 2 through 4, there are given actual brand name product representations. As an alternative, in some instances the products are not as such a nature as to have a brand name. In those instances, the signage could have representations of the products themselves. For example, if the products are of raw foods and vegetables, there could be representations of these.

Now let us examine one more issue, and this is by giving representations of rather specific products, are we giving the customer useful information as to locations of the various products that are in that aisle. The answer is definitely in the affirmative, and to do this we have to go back to our earlier discussion about the way a person will go through a store and look for certain products. The grocery store customers over the course of a number of years have probably made dozens or even a hundred or more visits to a grocery store and quite often the products of a certain type which are in the same broader category would tend to be placed in the same general location in that store. Thus, when a person looks at the representation of a can of V-8 Vegetable Juice, the person automatically makes the association that this is in the general class of canned food products, and more specifically canned products that relate to liquid beverages, and yet more specifically to beverages which are derived from fresh food products such as vegetable or fruit. Thus, the representation of the can of V-8 Juice provides at least as much information as the generic word “vegetable juice”.

Second Embodiment of the Present Invention

The second embodiment of the present invention is shown in FIGS. 6, 7 and 8. It will be recalled that earlier in this text, with reference to FIG. 2, it was indicated that the horizontal oval represented a category directory sign. In FIG. 2, it can be seen that the more specific directory signs are located at a large number of locations in the frozen food section, and in the drugstore section, and also in the deli section, and the bulk food section. It is to be recognized that these category directory signs can also be positioned at various product locations in the canned, bottled and packaged section, but these are not shown in FIG. 2, simply to keep the drawing from getting too cluttered.

In FIG. 6, there is shown a rather simple sign showing two frozen products in the category of frozen desserts. These are placed at an upper location on the side of the aisle adjacent to the frozen food cabinet. The sign conveys information that particular area there are in that particular area, there are a number of dessert products that are frozen.

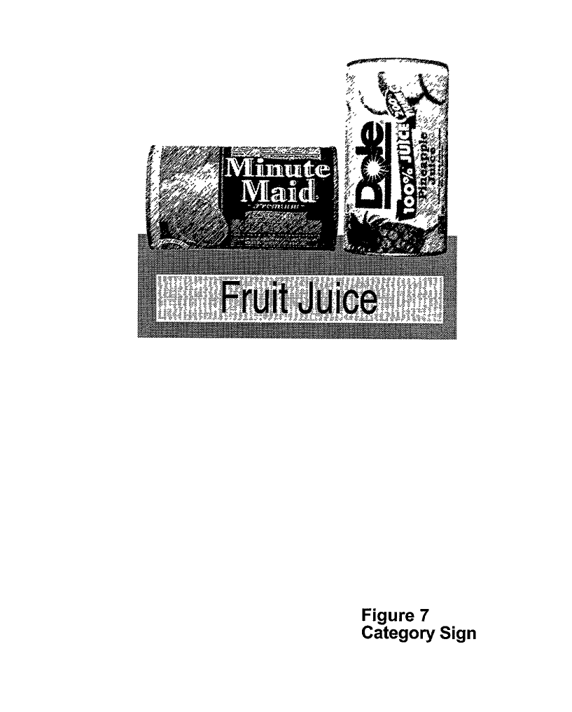

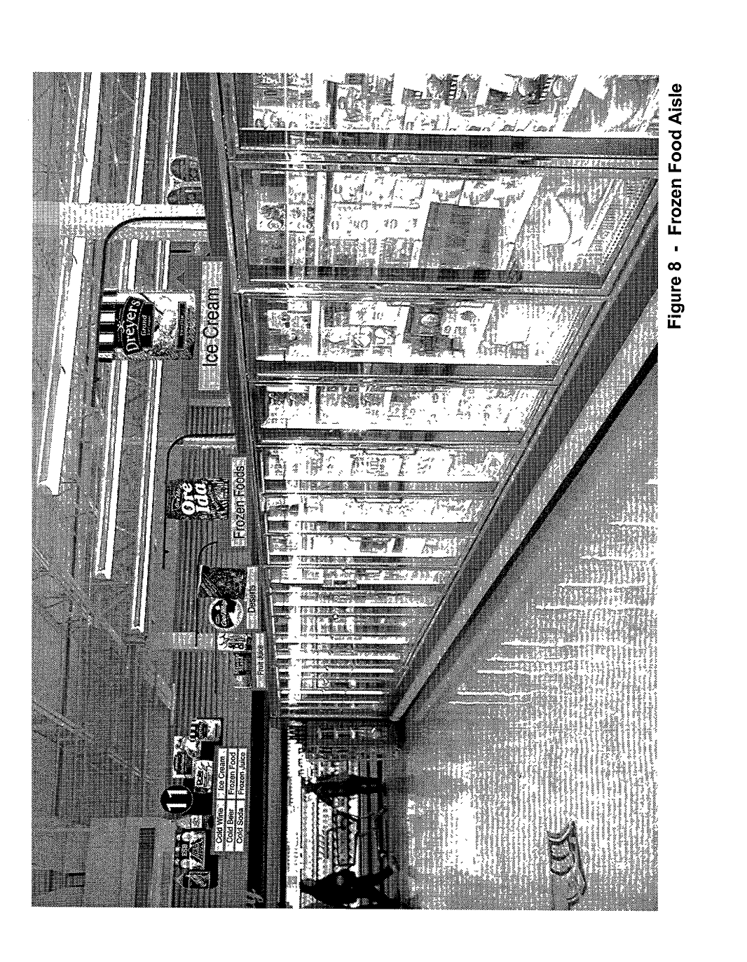

In the representation of FIG. 7 of the second embodiment, there is a sign having the designation “fruit juice” and also showing two frozen fruit juice products with well known name brands, namely “MINUTE MAID” and “DOLE”. The type of locations in the store where these would be used is illustrated in FIG. 8, which is in the frozen food section. As indicated earlier in this text, in the frozen food section many of food products are located in refrigerated cabinets, and can be seen through transparent doors. It can be readily appreciated from looking a FIG. 8 that one could very quickly ascertain the location of particular types of frozen food products. However, these signs give more than just information concerning the location, but the representation of the actual product within that category gives a “memory hook” where the person would be more likely to recall the particular location of that product as well as closely related products. Thus, the packaging of the “Dreyer's” ice cream product is already know to many customers, and the visual impression of seeing that graphic representation at that location is much more likely to stick in the person's mind than simply the word listing of “ice cream”.

The Third Embodiment of the Present Invention

A third embodiment of the present invention is a direction sign illustrated in FIG. 9. The information sign in FIG. 9, having both the word representation of the store location, is a representation of a product in that category, and an arrow is next to it. Again, the graphic representation serves as a “memory hook” in that the person can visualize a carton of ice cream with an arrow pointing in a certain direction. The combination of the arrow and the graphic depiction of the product are more easily remembered than an arrow plus a word representation.

The Fourth Embodiment of the Present Invention

This is a store directory, with the upper left corner of that directory being shown in FIG. 10. It will be recalled that in FIG. 2 there are shown the locations of several store directories, these being represented by an elongate rectangle. As shown in FIG. 2, there are four such store directories at spaced locations in the shopping area.

There could be as many as one hundred or more products or product categories listed, and these would normally be listed alphabetically. As an alternative, there could be groups of alphabetical listings under the headings of the primary categories. For example, the product “potatoes” would likely be interpreted as referring to the raw product which would be in the fresh food and vegetable section of the store, but there are also potatoes in other forms. Also, green beans could be in at least three different sections, namely the fresh vegetable section, the canned food section, and also the frozen food section. Accordingly, it may be desirable to group these alphabetically under the several broader categories.

As can be seen in FIG. 10, there is with each word designation of the product a specific brand name product representation. As indicated previously, this would provide a “memory hook” that could be associated with the numerical designation of the aisle.

The Fifth Embodiment of the Invention

In FIG. 11, there is shown a representation of a plan view of the supermarket and this can be presented on a sheet of paper or some other substraight. This could be used in various ways. For example it could be given as a handout to customers who are coming into the store to ascertain the overall layout of the store. Before giving FIG. 11 a close perusal, it is suggested that the reader, rather than examining each part of the drawing carefully, simply make a very quick overview in about two or three seconds of the entire representation of FIG. 11. It will be recognized that this provides an immediate impression of the overall layout of the store.

Do the brand name product representations help? Or even just the brand name alone? A moment's reflection would indicate that they unquestionably do. For example, as soon as a person looks in the lower left hand corner, the person sees the word “BAYER”, which automatically conveys the idea of pharmaceutical type products in a corner of the store. Then, in the right hand picture of this drawing there is an representation of a pineapple. This immediately gives the viewer the message that this is where the fresh produce is located. And in like manner the representation of the bottle of “COCA COLA” gives very prompt information that not only would “COCA COLA” be located at is represented location but many other soft drink products as well as the products that would normally be sold in the same area as the “COCA COLA” product. In the center part there is the picture of a “CAMPBELL'S” soup can. This automatically tells a person that this is the section where there is a broad category of canned food products, and it also gives a more specific bit of information as to where the canned soup would be.

Sixth Embodiment of the Present Invention

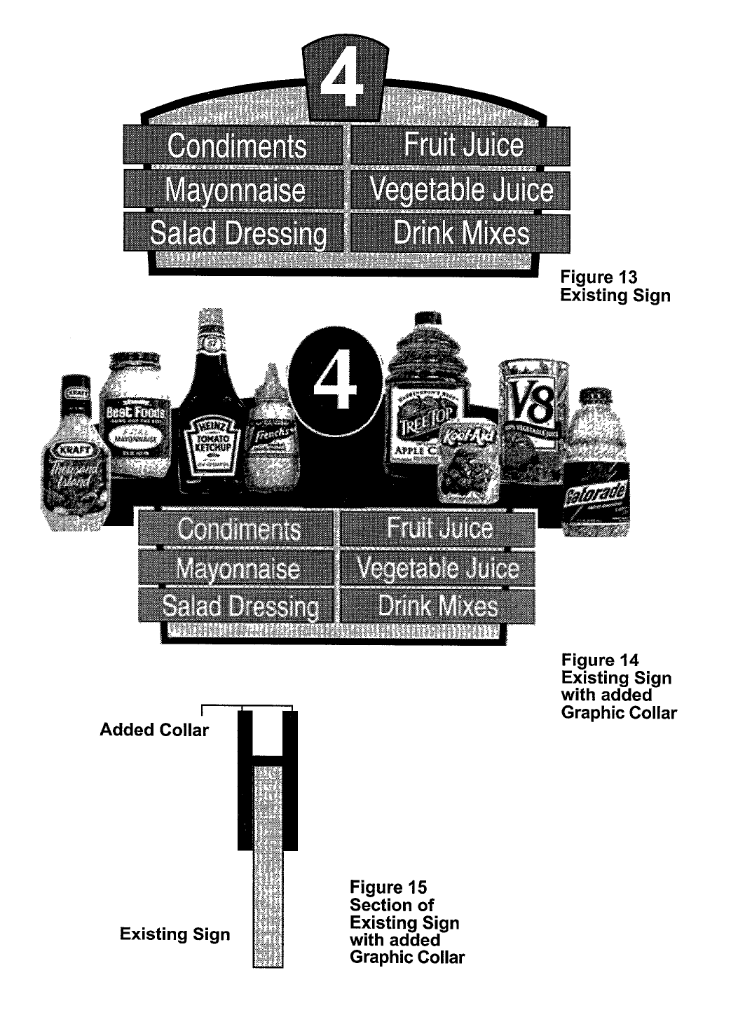

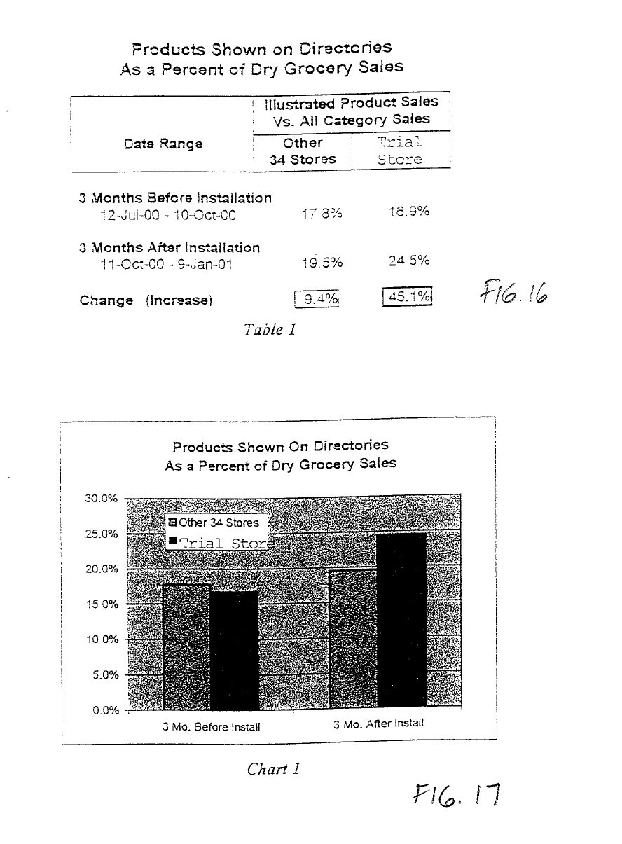

With regard to the manner that the various signs can be mounted, this, of course, could be accomplished by conventional means. Also, in accordance with a sixth embodiment of the present invention, the product display signs of the present invention could be mounted to existing text signs that are already in the aisles of the supermarket. For example, as shown in FIG. 13, the text sign 10 could already be installed in the store, and a u-shaped frame 12 could be placed over the edge portions of the existing text sign. The product display sign at 12 could be mounted to mounting frame 12 prior to placing the mounting frame on the existing text sign.

FIG. 14 shows the mounting frame by itself. It can be seen that it has a top cross piece 16 and two arms 18 extending downwardly therefrom. The cross-sectional view of these frame members 16 and 18 is shown in FIG. 15, and it can be seen in the cross-section has a top piece 20 and two side flanges 22 defining a recess 24. The edges of the existing sign fit into the recessed 24.

Other Features of the Present Invention

To determine the results that might be achieved by the present invention, the first embodiment of the present invention was tried out in an actual supermarket as part of a more comprehensive case study involving 34 additional supermarkets. This was done as follows:

a. Case Study.

The entire study took place over a period of six months, and the six months was divided into a first three month period in which a base line was established as a basis for comparison and a second three month period where a selected one of the stores was used on a trial basis by implementing the first embodiment of the present invention in that store for the three month period. The trial store which was selected had a shopping area of 47,000 square feet. Twelve signs in accordance with the first embodiment of the present invention were created, and these are shown in the six figures of drawings which are designated FIGS. 12a-12f, with each sheet showing two of the signs. There are 94 dry grocery products illustrated on the signs. These 94 brand name products represent nearly one thousand products in total. The strawberry jello represented all flavors and sizes of jello desert, and the Gatorade as illustrated represented all sizes and flavors of Gatorade, while the 409 Cleaner only represented itself. To improve the reliability of the test, variety department (non-food items) and alcoholic beverages were not included in the study. Since the marketing of these products vary substantially from store to store, and also between the two three month time periods during which the tests were conducted.

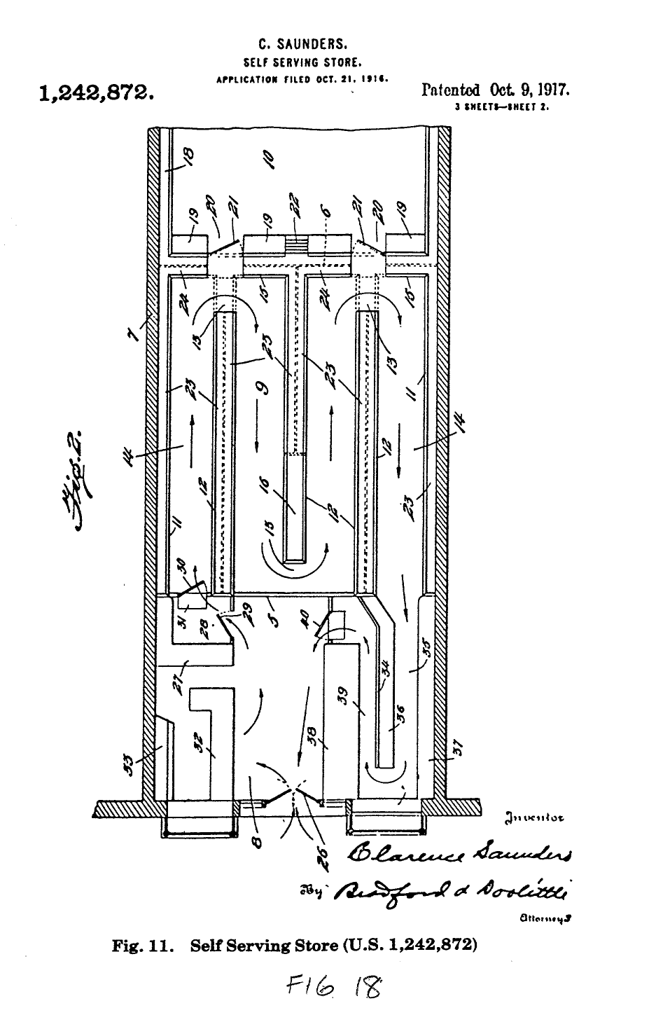

In the first three month period, the sales of the products which are identified in the signs were tracked closely in all 35 stores. Also, the sales for those particular products were tracked separately in the Trial Store. With reference to FIG. 17, it can be seen that for the three month period from Jul. 12, 2000 to Oct. 10, 2000 for the 34 stores the percentage sales level for the products that appear on the signs with 17.8%, while in the trial store it was a little bit less, namely 16.9%.

It is to be noted that the text portions of each of these signs were displayed in the store in the first three month period, and that the brand name product representations were added for the second three month period.

Then during the second three month period, the signs which are illustrated in FIGS. 12A-12F were placed in the trial store, with nine of the signs being placed as in pairs at opposite ends of nine longer aisles and the remaining three signs being placed only at one end of the shorter aisles. At the end of the three month period, then the sales of these particular grocery store items were tabulated. It can be seen, again with reference to FIG. 17 that there was an increase in sales for the other 34 stores of 9.4%, while the increase in sales in the trial store was 45.1%. These results are illustrated in the graph of FIG. 18.

This case study leads us into two avenues of thought. First, this would indicate that the brand name product representation signs, when used in addition to the word signs do get more attention from the consumer, more specifically, it attracts the consumer's attention to the extent that it would actually lead the person who is traveling down that aisle to identify and actually purchase the item which is shown on the brand name product representation signs. Thus, this demonstrates that the very practical benefit of making the customer more familiar with the products that are offered and also the location of these products in various locations in the store.

The second avenue of thought into which we are led by this case study is the advertising value of the brand name product representation signs. To put this in more direct terms, it helps to sell the products that are shown. This could be used, for example, an inducement for the producers of these displayed products to at least defray the cost of placing the representations of its products on location identifying signs. Beyond that, the participation of the producers of the food products in this system could actually provide additional revenue for the store.

Also, it was found in this particular case study that the consumer response in this particular store where the brand name product representation display signs were used was overall positive. While no statistical study was done in this regard, the feedback which is received by the people who are serving the customers in this store, during this three month test period, is that the customer responses would be along the following lines:

“It's so easy to find things. You don't have to read—just look at the pictures.”

“Finding what I need is so fast. I can scan the whole store in a few seconds and pick out the stuff I'm looking for”.

“It's the quickest way to find stuff in any store I've ever shopped”.

Also, the product representations that are placed on the product display sign 14 could be prepared in various ways. Again, these are well known to those who are skilled in the advertising and graphics industry. There is no need to discuss those in detail in this text. In some instances it may be desired to make changes in the product display signs, and in that instance there could be a stock of representations of the various brand name product representations, and these could be placed in a collage and copies made from the physically assembled collage. Alternatively, with the significant advances in computer technology, these images could be moved around on the display screen and re-arranged in attractive formats.

It is recognized that various modifications could be made in the present invention without departing from the basic teachings thereof.

Therefore, I claim:

1. A system to facilitate consumer shopping in a store facility having store products in a shopping area where said products are categorized as:
a. products in a plurality of primary location related product categories with the products in each primary location related category being in a related primary location area of the shopping area;
b. products in each primary location related category which are in turn classified in a plurality of secondary location related categories, with the products in each secondary location related category being in a related secondary location area;
c. products in at least some of said secondary location related categories being in subcategories of a related one of the secondary location related categories;
said shopping area having a plurality of consumer access regions which are proximate to the products in the shopping area and through which customers are able to pass in making product selections from adjacent products which are adjacent to that access region, each of said access regions being characterized in that the adjacent products are classified in one or more of said secondary categories and/or subcategories;
said system comprising:
a. a plurality of display signs, each of which is located at a related access region for viewing by customers at or proximate to that related access region, each of said display signs having at least one graphic product representation of a product which is one of said adjacent products and is representative of products in its related secondary location related product category or subcategory at its related access region;
b. said display signs being positioned in a substantial shopping area portion of the shopping area and located at a substantial number of access regions in said substantial area portion, such that a customer passing through the access regions in said store shopping area portion is able to associate said graphic product representations as representative of products in a subcategory and/or a secondary location related product category of the product or products of the graphic product representations, and thus identify primary, secondary and/or subcategory location in the shopping area portions as a guide to seeking products in the substantial shopping area portion where the graphic product representations are present.

2. The system as recited in claim 1, wherein at least some of the products of the graphic product representations display a brand name and said brand name is visible in the graphic product representations.

3. The system as recited in claim 2, wherein some of said products of the graphic product representations have package design which is visible in the graphic product representation.

4. The system as recited in claim 1, wherein a substantial portion of said products of the graphic product representations have a brand name and an associated package design, and the graphic product representations are recognizable representations of the brand name and associated package designs.

5. The system as recited in claim 1, further comprising at least one store directory which is visible to customers in the shopping area, said store directory listing identifying names of products, with each identifying name of the product also having a graphic product representation substantially displaying packaging of a brand name product which is within the scope of the product listed in the directory.

6. The system as recited in claim 1, wherein there is also at least on display direction sign indicating a direction to a store location or locations and providing identification of the store location or locations by means of a graphic product representation of a brand name product or products that is representative of product or products in that location or locations.

7. The system as recited in claim 1, wherein there is at least one store directory which is a representation of the shopping area showing various product locations in the store area and identifying at least a portion of these store locations by graphic product representations of specific products representative of products to be found at that location.

8. The system as recited in claim 1, wherein there is a plurality of store directories which are representative of the shopping area showing various product locations in the store area and identifying these store locations by graphic product representations of specific products representative of products to be found at that location, said store directories being printed on a substraight that is portable manually so as to be able to be given as handouts for store information and/or for advertising and/or other purposes in conveying information on the store facility.

9. The system as recited in claim 1, wherein a substantial percentage of the products in the shopping area are food products and food related products, and the primary location related product categories include at least frozen food products, refrigerated food products, fresh (perishable) food products, and canned/bottled/packaged food products, and said access regions of said store facility comprises at least elongate aisles with product shelves along the aisles, and each of said aisles is provided with at least one aisle display sign which has displayed thereon a plurality of graphic product representations of products representative of the secondary location related product categories and/or subcategories of food products in shelves along that aisle.

10. The system as recited in claim 9, wherein there is also of said category directory signs at spaced locations along at least some of said aisles, and displaying graphic product representations which are more specific to product categories at said spaced locations along said aisle.

11. The system as recited in claim 10, wherein said at least one aisle is an aisle at which frozen products are present and located in freezers cabinets.

12. The system as recited in claim 10, wherein the products of said store facility also include “drug store” products, and said category directory signs are at spaced locations in a section where the shopping area where the drug store related products are located.

13. The system as recited in claim 9, wherein at least some of said display signs have in addition to the graphic product representation or representation text identifying products and/or categories of products at the related access region.

14. The system as recited in claim 13, wherein said store facility has existing display signs at access regions which display text identifying products and/or categories of products at the access region, and graphic product representations are displayed in addition to the text.

15. The system as recited in claim 1, where there are existing display signs in the shopping area which display text identifying products and/or product categories, and there are in addition signed displays that display the graphic product representations having a mounting structure by which the display signs having the graphic representation can be positioned adjacent to a corresponding display sign at the access region.
